(19) United States
(12) Patent Application Publication
(10) Pub. No.: US 2026/0150809 A1
(43) Pub. Date: Jun. 4, 2026

(54) ANIMAL FEED CONTAINER

(71) Applicant: Daniel VON ARX, Montreux (CH)

(72) Inventor: Daniel VON ARX, Montreux (CH)

(21) Appl. No.: 19/398,188

(22) Filed: Nov. 24, 2025

(30) Foreign Application Priority Data
Nov. 29, 2024 (CH) CH001310/2024
Nov. 29, 2024 (DE) 20 2024 106 931
Nov. 29, 2024 (EP) 24216621.3

(51) Int. Cl. A01K 5/01; A01K 5/02

(52) U.S. Cl. CPC A01K 5/01; A01K 5/02

(57) ABSTRACT

Animal feed container allows for a reliable and controlled feed supply for farm animals and wild animals, in particular for horses. The container includes a housing with a floor plate, two side walls and a front wall and a rear wall. A vertically displaceable platform for storing animal feed is arranged within the housing. A spring-actuated mechanism automatically raises the platform in the direction of the upper opening, while the operating element, a foot pedal, brings the platform into a lowered position and fixes it in order to simplify the filling of animal feed, in particular hay, through a lateral opening. After releasing the operating element, the mechanism raises the platform again, whereby a continuous and rationed feed supply is ensured.

### CROSS REFERENCE TO RELATED APPLICATIONS

Applicant claims priority under 35 U.S.C. § 119 of European Patent Application No. 24216621.3 filed Nov. 29, 2024, Swiss Patent Application No. CH 001310/2024 filed Nov. 29, 2024, and German Patent Application No. 20 2024 106 931, the disclosures of which are incorporated by reference.

### BACKGROUND OF THE INVENTION

### 1. Field of the Invention

The present invention relates to an animal feed container for the supported storage and controlled dispensing of animal feed, in particular hay, for farm animals and wild animals.

### 2. Description of the Related Art

Animal feed, in particular hay, is of central importance for feeding farm animals and wild animals. Hay is used especially for animals, such as horses, cows and other herbivores, which depend on a regular supply of high fiber feed in order to maintain good digestion and to ensure an optimal absorption of nutrients. Traditionally, hay is stored in large bales of 22 to 35 kilograms and is distributed manually. These hay bales are often thrown loosely into the stable or onto pastures, so that the animals have to receive feed directly from the floor. However, this practice has health as well as economic disadvantages.

The uncontrolled feed receipt of the animals is a main problem with the conventional method of placing hay directly onto the floor. For example, horses tend to eat excessively when they have free access to large quantities of hay. The reason for this is that in the wild, horses are by nature predisposed to graze continuously and to receive feed in small quantities throughout the day, which corresponds to their natural digestive physiology. In a stable where the hay is present loosely and in large quantities, however, they can eat large quantities in a short time, which often leads to digestive problems. This can cause constipation, colics and other serious health problems, which require veterinary intervention. The treatment of such problems is not only costly but can also represent a serious threat to the health and the life of the animals.

In addition to the health risks, the loose spreading of hay is associated with further disadvantages. Due to the fact that the hay is thrown directly onto the stable floor, it comes into contact with manure and urine, which seriously affects the quality of the feed. The animals often do not eat hay, which is contaminated with feces and urine, which leads to significant loss of feed. This waste is particularly problematic because high-quality hay is becoming increasingly expensive in many parts of the world, in particular in Europe, due to the increased demand. A significant portion of the European hay production is exported to countries, such as Saudi Arabia, as animal feed, which leads to a shortage and to increasing prices in the local markets.

To counteract these problems, different systems for dispensing feed have been developed in order to improve the feeding processes. The use of nets, in which the hay is packed and hung, is a widespread method for controlling the feed receipt. These nets make it possible for the animals to slowly pull off the hay, much like when grazing in nature. The advantage of this method is that the animals cannot receive feed without limits, which reduces the risk of digestive problems. However, this method has proven to not be very practicable in practice. The nets have to be maintained and checked on a regular basis because they lose function in response to being damaged or worn and the hay becomes accessible in an uncontrolled manner again. In addition, the filling and hanging of the nets is labor-intensive and time-consuming, which places a significant strain in particular on larger farms or horse stables, in which several animals have to be fed simultaneously.

In addition to the nets, there are also commercial feed boxes, which are to enable a controlled dispensing of feed. These systems are designed to regulate the feed quantity and frequency in order to prevent an excessive feed receipt. However, many of these feed boxes offer only limited adaptability and are often not able to consider the individual feed needs of different animals. In addition, the handling thereof is often complicated and requires a high maintenance effort. In addition, the feed quality can deteriorate quickly in such systems, in particular when the hay becomes too dry, which can lead to respiratory problems or allergies in the animals.

In modern livestock farms, in particular when keeping horses, there is thus a significant need for an efficient, cost-efficient and user-friendly solution for the dispensing of feed. An even feed distribution is likewise essential, especially in winter months, when wild animals, such as deer, are dependent on human feed supply in order to provide the animals with a continuous food availability.

### OBJECT OF THE INVENTION

In light of the foregoing, it is the object of the present invention to provide an animal feed container, which offers a reliable, adaptable and easy to use solution for storing and dispensing feed.

### SUMMARY OF THE INVENTION

The present object is solved by means of an animal feed container with the features according to the invention. Preferred embodiments of this animal feed container are discussed below.

In detail, an animal feed container according to the invention comprises a housing with a floor plate, two side walls as well as a front wall and a rear wall, a platform guided in a vertically displaceable manner within the housing for storing animal feed, a spring-actuated mechanism for raising the platform in the direction of an upper opening of the housing, an operating element for lowering and fixing the platform in a low position, and a lateral opening for inserting animal feed into the animal feed container when the platform is fixed in the low position, wherein the spring-actuated mechanism is configured so that, after releasing the operating element, the platform is pushed in the direction of the upper opening in order to ensure a continuous animal feed supply.

The animal feed container according to the invention allows for a controlled, continuous feed supply, which corresponds to the natural eating habits of animals, such as horses. With the spring-actuated mechanism, the feed is pushed upwards evenly, whereby the risk of overeating and of digestive problems is reduced. In addition, the hay remains protected from contamination caused by manure and urine, which maintains the feed quality and reduces losses. The lateral opening simplifies the refilling, while the operating element lowers and fixes the platform. This reduces the amount of work and minimizes waste of hay, which leads to lower feed costs. As a whole, the container offers an efficient and animal-friendly feeding solution, which promotes the animal health as well as increases the economic efficiency in livestock farms.

It is preferred that the housing and/or the platform are made of high-grade steel, in particular stainless steel, and/or plastic.

The materials of high-grade steel and plastic offer durability, hygiene and simple handling of the container.

It is further preferred that the platform has a horizontal base plate, which carries the animal feed on its upper side facing the upper opening and which has several sleeves, preferably four sleeves arranged in the corner areas of the base plate, on its underside facing the floor plate, wherein each sleeve serves as outer guide for a cylindrical compression spring, which extends vertically and which supports itself with its upper side on the underside of the floor plate and exerts a vertical compressive force upwards against the platform.

This preferred embodiment of the animal feed container according to the invention with sleeves as outer guide for the compression springs ensures an even distribution of the spring force and prevents the canting of the platform. The feed is thus pushed upwards continuously and is released in a controlled manner, which corresponds to the natural feed receipt of the animals. This even raising of the platform minimizes feed waste and supports the health of the animals by means of controlled feed supply.

It is additionally preferred in this context that in the case of four sleeves, which are arranged in the corner areas of the platform, two sleeves, which each lie opposite one another in a direction perpendicular to the front wall and rear wall, are connected to one another by means of a fixed cross strut, and the two cross struts, in turn, are connected to one another by means of a fixed longitudinal strut, which runs perpendicular to the side walls.

The preferred embodiment with cross struts and longitudinal strut stabilizes the platform and prevents a canting. This ensures an even distribution of the compressive force and a reliable raising of the feed. The increased structural stiffness ensures an even dispensing of feed and improves the durability as well as the operational safety of the container.

It is furthermore preferred in this context that the floor plate has several columns, preferably four columns arranged in corner areas of the floor plate, wherein each column serves as inner guide for the cylindrical compression spring, which extends vertically and which supports itself with its underside on the floor plate and exerts a vertical compressive force upwards against the platform.

This embodiment with columns in the corner areas of the floor plate improves the stability of the raising mechanism, in that said columns precisely guide the compression springs and prevent canting of the platform. This allows for an even feed supply, improves the operational safety and reduces the maintenance effort, whereby the container becomes more durable.

A further particularly preferred embodiment of the animal feed container according to the invention is that the operating element is a foot pedal, which is fixedly connected to the platform and which is operable by the operator by foot and fixable in the low position.

This embodiment with fixedly mounted foot pedal allows for a simple, hands-free lowering and fixing of the platform, simplifies the refilling of feed, increases the safety due to stability of the platform and reduces the physical strain.

In yet a further preferred embodiment of the invention, it is provided that a locking element, for example an L-shaped bracket, is fastened to the floor plate, which locking element is locked in a positive manner with the operating element in the low position in order to thus fix the operating element as well as the platform, which is fixedly connected thereto, in the low position.

The embodiment with a locking element securely fixes the platform in the low position, which simplifies the refilling of feed and which prevents the platform from being raised unintentionally. This increases the safety and efficiency, in particular when handling heavy hay bales.

In yet a further preferred configuration of the invention, the front wall has a slot, which extends in the vertical direction from the floor plate and through which the operating element is operable by an operator.

This configuration with a slot in the front wall allows for a simple, safe operation of the operating element from the outside, simplifies the feeding process, improves the ergonomics and increases the efficiency when refilling feed.

A further preferred embodiment of the invention provides that the lateral opening has a flap, which is fastened in an articulated manner and which enables the easy opening and closing of the housing, wherein the flap is connected in an articulated manner either to the front wall or the rear wall and forms the entire side wall in the closed state, or wherein the flap is connected in an articulated manner to the side wall and forms a part of the side wall in the closed state.

This embodiment with a flap, which is fastened in an articulated manner, simplifies the refilling of feed and offers flexible access, in that the flap is attached to the front wall, rear wall or side wall. In the closed state, the flap protects the feed against external influences. Depending on the embodiment, the flap covers the entire side wall or only a portion of the side wall, which improves the operation and protection of the feed.

According to a particularly preferred configuration of the invention a grate-shaped cover is connected in an articulated manner to the upper edge of the rear wall and is closeable via a locking device on the front wall in order to cover the upper opening in the closed state and to enable a rationed animal feed supply.

A controlled feed receipt is thus made possible because the animals can pull off the feed only in small quantities through the grate-shaped cover. This promotes a healthy digestion and ensures a simple operation.

A closure lid is preferably furthermore provided, which is connected in an articulated manner to the upper edge of the rear wall in order to completely close the upper opening and to stop the receipt of animal feed, and wherein the closure lid preferably has one or several indentations, which serve as concentrated feed depressions.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a perspective overall view of a preferred exemplary embodiment of an animal feed container according to the invention;

FIG. 2 shows a front view of the animal feed container according to FIG. 1;

FIG. 3 shows a vertical lateral cross sectional view along the section line A-A in FIG. 2;

FIG. 4 shows a top view of the animal feed container according to FIG. 1;

FIG. 5 shows a perspective single view of the housing included in the animal feed container according to FIG. 1;

FIG. 6 shows a front view of the housing according to FIG. 5;

FIG. 7 shows a top view of the housing according to FIG. 5; and

FIG. 8 shows a perspective single view of the platform included in the animal feed container according to FIG. 1.

### DETAILED DESCRIPTION OF PREFERRED EMBODIMENTS

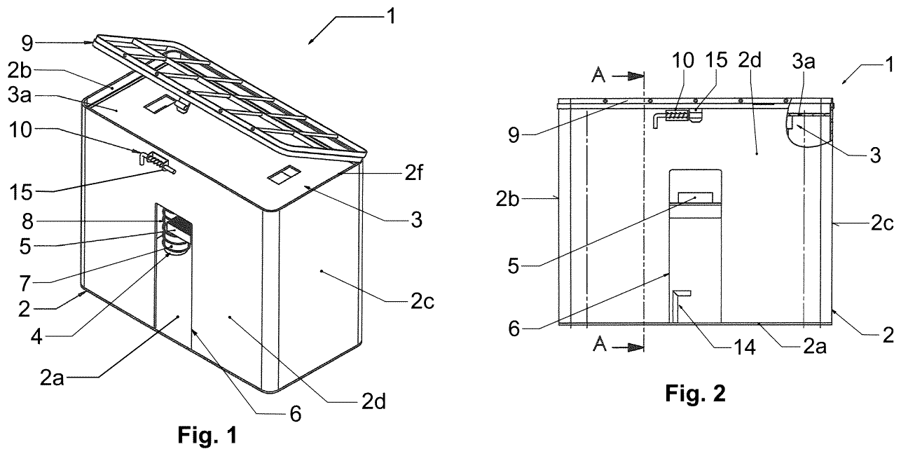

The feed container 1 according to the invention is shown in a schematic, isometric overall view in FIG. 1. It comprises a cubic-shaped housing 2 with two side walls 2b, 2c lying opposite one another in parallel as well as a front wall 2d and rear wall 2e arranged perpendicular thereto, which likewise lie opposite one another in parallel. A vertically displaceable platform 3, which comprises a base plate 3a, is located within the housing 2. The upper side of the base plate 3a serves the purpose of storing the animal feed. The platform 3, on which no animal feed rests, is illustrated in FIG. 1 in its highest position, close to the upper opening 2f of the housing 2.

The housing 2 and/or the platform 3 of the animal feed container according to the invention consist of high-grade steel, in particular stainless steel, and/or plastic. High-grade steel offers high strength, resistance to corrosion and hygiene, which makes it ideal for moist stable environment. Stainless steel additionally prevents the formation of rust. Plastic is lighter, more cost-efficient and flexibly formable, whereby the handling is simplified. Both materials can be cleaned easily, are resistant against chemicals and offer a long-lasting solution, which meets the demands in modern livestock farms. The combination of these materials ensures stability, hygiene and user-friendliness.

The platform 3 is raised by means of a spring-actuated mechanism 4 in the vertical direction in the direction of the upper opening 2f of the housing. This mechanism 4 consists of several cylindrical compression springs 8, one of which can be seen in FIG. 1. These compression springs 8 exert a vertical force on the platform 3 in order to push it upwards.

Hay serves as animal feed, which is to be supplied to an animal, in particular a horse, in a controlled and rationed manner by means of the container 1 according to the invention. However, the container 1 is also suitable for other feed, such as silage, straw or concentrated feed, which is likewise processed in bales or larger quantities and which requires a controlled feed supply.

Hay bales are pressed in a cubic shape and have a considerable weight. For people with limited physical constitution, the lifting of the hay bales into the upper opening 2f of the animal feed container 1 can represent an insurmountable challenge. For this reason, one of the side walls 2b has a lateral opening, which is not illustrated in the figures. The hay bale can be inserted into the container 1 through this lateral opening with little physical strength using a wheelbarrow.

So that the hay bale can be inserted laterally, however, the platform 3 must be in a low position. In order to make this possible, the platform 3 has to be moved vertically downwards against the spring force of the spring-actuated mechanism 4. An operating element 5 in the form of a foot pedal is provided for this purpose. The foot pedal 5 is fixedly connected to the platform 3 and is movably supported within the housing 2, for example on a guide rail.

In order to be able to comfortably operate the foot pedal 5, a vertical slot 6 is provided in the front wall 2d of the housing. The operator can insert his/her foot into this slot 6 and can push the foot pedal 5 vertically downwards, whereby the platform 3 also moves vertically downwards. As soon as the platform 3 has reached its low position, the hay bale can be pushed comfortably to the upper side of the base plate 3a from the side.

The slot 6, which extends vertically upwards from the floor plate 2a of the housing 2, can be seen clearly in FIG. 2, which shows a front view of the animal feed container 1 according to FIG. 1. This slot 6 is dimensioned so that it takes into account the vertical lift of the platform 3, which is necessary to insert a hay bale into the housing 2 and to subsequently provide it to the animal almost completely. In the lowest position of the platform 3, the base plate 3a is positioned at a height, which enables a lateral insertion of the hay bale through an opening in the side wall 2b. In the highest position, as illustrated in FIG. 2, the base plate 3a is located close to the upper opening 2f of the housing 2, whereby the hay can be received or eaten, respectively, almost completely by the animal.

As likewise illustrated in FIG. 2, an L-shaped locking element 14 is attached to the floor plate 2a of the housing, which locking element locks the foot pedal 5 in a positive manner in the lowest platform position. This locking prevents the platform 3 from being pushed upwards again autonomously under the action of the force of the spring-actuated mechanism 4. The operator, who has moved the platform 3 downwards by means of the foot pedal 5, can insert the hay bale through the lateral opening after locking the foot pedal 5. This mechanic significantly reduces the personnel expenses.

A free gap, which enables the interference-free vertical movement of the platform 3, remains between the outer edges of the base plate 3a and the inner walls of the housing 2. Additional profiles are preferably provided on the outer edges of the base plate 3a in order to prevent that hay falls into the lower area of the housing 2.

The spring-actuated mechanism 4 installed within the housing 2 for raising the platform 3 in the direction of the upper opening 2f of the housing can be seen particularly well in the vertical lateral cross sectional view according to FIG. 3. This spring-actuated mechanism 4 comprises four compression springs 8, which extend from the four corner areas of the floor plate 2a of the housing 2 to the corresponding corner areas of the underside of the base plate 3a of the platform 3. After releasing the foot pedal 5 from its locking, the compression springs 8 continuously exert a vertical force on the platform 3, so that the hay stored thereon is pushed evenly in the direction of the upper opening 2f of the housing 2. This ensures a steady and controlled hay supply for the animal, in particular for a horse.

The compression springs 8 are equipped with an inner and outer guide in order to prevent a buckling and to ensure a reliable force transmission to the platform 3. The inner guide is formed by four vertically running columns 7, which are fastened in the corner areas of the floor plate 2a and onto which the compression springs 8 are in each case placed in the same way as onto a mandrel. The outer guides are formed by vertically running sleeves 11, which are fastened to the corresponding corner areas of the base plate 3a of the platform 3 and which surround the compression springs 8 from the outside.

In the lowest platform position (suggested by dot-dash lines in FIG. 3), the sleeves 11 and the columns 7 are moved completely into one another, wherein the compression springs 8 are arranged therebetween in the maximally compressed state. The hay quantity decreases in the course of the feeding process, whereby the compression springs 8 relax and the platform 3 is pushed upwards together with the hay. The sleeves 11 thereby move telescopically vertically upwards along the stationary columns 7. The lower sections of the compression springs 8 become visible during the upwards movement of the platform 3, while the upper sections still remain in the sleeves 11, which are fixedly attached to the base plate 3a of the platform 3. The vertical lengths of the sleeves 11 and of the columns 7 are dimensioned so that a partial overlap is maintained between them even in the maximally extended position, as illustrated in FIG. 3. A simultaneous inner and outer guidance of the compression springs 8 is thus ensured in sections.

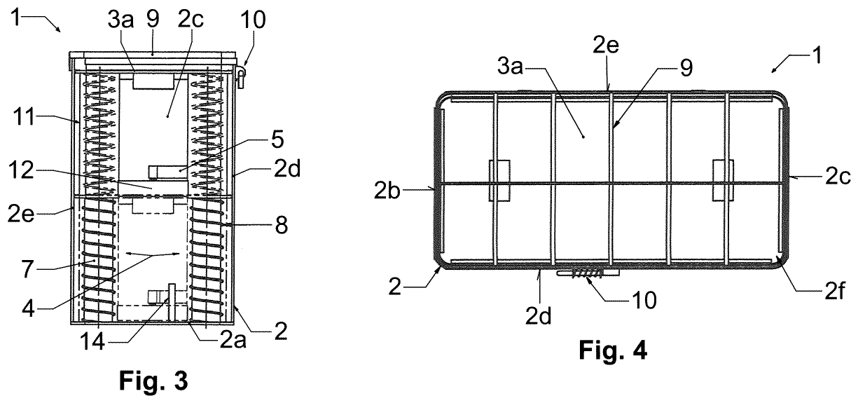

The grate-shaped cover 9, which covers the upper opening 2f of the animal feed container 1, can be seen particularly well in the top view according to FIG. 4. As already illustrated in FIG. 1, this grate-shaped cover 9 is connected in an articulated manner to the upper edge of the rear wall 2e. In the open or half-open state, as shown in FIG. 1, the base plate 3a can be cleaned and in particular residual hay can be removed.

In order to reliably close the upper opening 2f by means of the grate-shaped cover 9, a locking device 10 in the form of a spring-actuated lever is provided on the front wall 2d of the housing 2, which locking device engages with a corresponding eye 15 on the front edge of the grate-shaped cover 9. The grate-shaped cover 9 prevents the animal from eating the hay on the base plate 3a in an uncontrolled manner and, in the closed state as shown in FIG. 4, closes the upper opening 2 f. A controlled hay supply is thus ensured, which supports a healthy feed receipt.

This slow hay receipt simulates the natural grazing, in that the animal, in particular a horse, can pull off the hay only slowly through the openings of the grate, which is particularly digestion-friendly. An uncontrolled hay intake, as in the case of a floor distribution, is thus avoided. The cross sectional dimensions of the housing 2 illustrated in FIG. 4 are adapted to the shape and size of the standardized hay bales. Due to the spring-actuated mechanism 4 described in connection with FIG. 3, the hay bale is pushed continuously against the grate-shaped cover 9 during the entire feeding process, so that hay is available for the animal to pull off, even during longer unattended phases, such as, for example, on the weekend. This significantly reduces the personnel expenses.

In addition, two further preferred embodiments of the invention are conceivable, which are not illustrated in the figures but which can be realized individually as well as in combination in the context of the invention.

Integrated moistening device: a moistening device integrated into the animal feed container 1 is connected to a water supply via a hose connection in order to moisten the animal feed, in particular a hay bale, which is stored on the vertically displaceable platform 3. This moistening device can be embodied, for example, as spray apparatus or drip system, which applies water to the hay in a demand-oriented manner. The quality of the hay is maintained with the systematic moistening thereof, dust formation is reduced and the feed receipt is achieved in a more comfortable manner for the animals. The integration of the moistening device into the housing 2 provides for an efficient water usage and simplifies the maintenance of the system. In addition, the moistening can be controlled automatically in order to ensure a constant moisture supply and to thus optimize the storage of the feed.

Sensor monitoring unit: a sensor monitoring unit, which is integrated into the animal feed container 1, monitors the current fill level of the animal feed by means of magnetic, capacitive or optical sensors and provides the corresponding data via a mobile app. This sensor monitoring unit makes it possible for the livestock owner to monitor the fill level of the feed in real time, to detect shortages early and to efficiently plan the feed supply. Magnetic sensors could measure the proximity of fill levels, capacitive sensors could determine the feed quantity on the basis of capacity changes and optical sensors could use visual signals for the fill level detection. The wireless data transmission takes place via Bluetooth or Wi-Fi, so that the livestock owner can comfortably access the information from a mobile device. This contributes to the optimization of the feeding processes, reduces the manual effort and prevents overfeeding or underfeeding of the animals.

These additional embodiments significantly expand the functionality of the animal feed container 1, in that they improve the quality of the feed with systematic moistening as well as simplify the management and monitoring of the feed inventories by means of modern sensor technology. A more efficient, more hygienic and more user-friendly feeding solution for modern livestock farms is thus created.

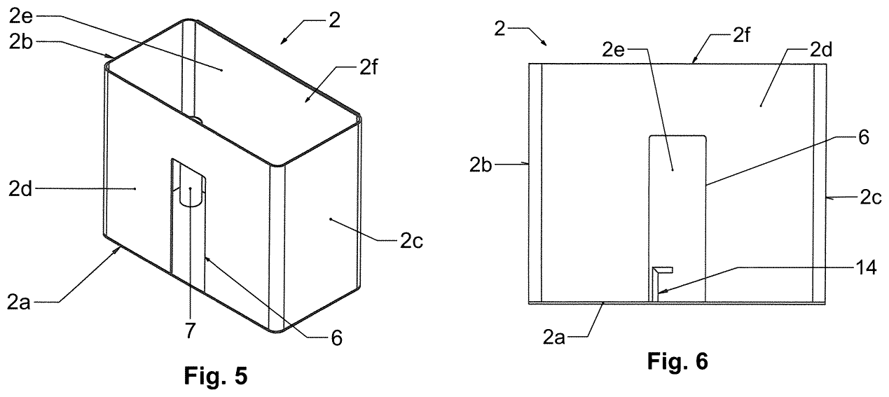

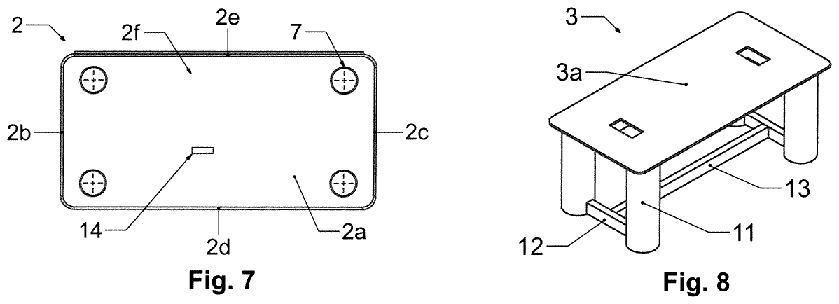

The isolated housing 2 of the animal feed container 1 according to FIGS. 1 to 4 is shown in FIG. 5 (isometric illustration), FIG. 6 (front view) and FIG. 7 (top view), that is, without the vertically movable platform 3, the compression springs 8 and the grate-shaped cover 9. The housing 2 is formed in an essentially cubic manner and is adapted with respect to shape and dimension to the hay bales, which are to be inserted laterally. It consists of a rectangular floor plate 2a, two shorter side walls 2b, 2c as well as a longer front wall 2d and rear wall 2e. All edges and corners of the housing 2 are rounded in order to prevent injuries to people and animals.

As follows from FIG. 5 and especially from FIG. 7, a respective column 7, which starts vertically at the floor plate 2a, is fastened, preferably welded on, in the four corner areas of the floor plate 2a, which is formed by a rectangular plate with rounded corners. The columns 7 act as inner guides for the cylindrical compression springs 8, which are attached to them, whereby a stable and straight course of movement of the compression springs 8 during the vertical movement of the platform 3 is ensured. Material and weight savings are achieved in that the columns 7 are not embodied in a massive, but tubular manner. These columns 7 of the housing 2, together with the cylindrical compression springs 8 and the sleeves 11 of the platform 3, form the spring-actuated mechanism 4, which serves the purpose of raising the platform 3 in the direction of the upper opening 2f of the housing 2 (see FIG. 3).

The rectangular, elongated slot 6, which starts at the floor plate 2a and extends approximately over two thirds of the total height of the housing 2, is provided in the front wall 2d (see FIG. 6). This slot 6 allows for the operation of the foot pedal 5, which is fixedly connected to the platform 3, in order to bring the latter into a lowered low position. In this position, the hay bale can be comfortably inserted through a lateral opening in the side wall 2b of the housing 2 in the horizontal direction. As can be seen in FIG. 6, the L-shaped locking element 14, which comes into engagement with the foot pedal 5, is attached to the floor plate 2a for the fixation of the platform 3 in the low position.

It can be seen particularly well in the top view according to FIG. 7, how the four columns 7 are arranged symmetrically in the four corner areas of the floor plate 2a. These columns 7 form the inner guides, which guide the compression springs 8 as mandrels on the inner side. An even pressure distribution is exerted on the platform 3 with the corresponding symmetrical arrangement of the compression springs 8 on the four corners of the floor plate 2a of the housing 2, and thus also on the four corners of the base plate 3a of the platform 3, so that a canting of the platform 3 is prevented. This ensures that the hay stored on the platform 3 is pushed evenly against the grate-shaped cover 9 over the entire horizontal cross sectional surface, whereby the animal can pull off the hay evenly over this entire surface. With the removal of the hay, the remaining hay is pushed upwards continuously by means of the compression springs 8, so that fresh hay is always available through the grate-shaped cover 9 until the complete consumption of the hay bale.

This allows for a semi-automatic supply of the hay for the animal, in particular for horses, in a structurally simple manner. Only the insertion of a new hay bale has to take place manually, whereby even this process is simplified significantly by means of the simple lowering of the platform 3 by means of the foot pedal 5 and the locking of the platform 3 by means of the locking element 14 and can be carried out in a short time.

As a result, the personnel requirements can be reduced significantly in modern stables, which often house a plurality of hay-eating animals. This represents a significant economic factor, in particular on weekends limited in terms of personnel.

Even though it is not illustrated separately, it is possible in the context of the invention to equip the animal feed container 1 with an additional closure lid. Said closure lid can be connected in an articulated manner to the upper edge of the rear wall 2e in order to completely close the upper opening 2f. Such a closure in particular serves the purpose of systematically interrupting the feed receipt, for example while cleaning the container 1, for the purpose of refilling feed or for the purpose of ensuring that an overfeeding does not take place. The closure lid can have, in particular on its upper side in the closed state of the container 1, one or several indentations, which serve as concentrated feed depressions. These indentations allow for the supply of additional concentrated feed, for example when changing feed or in order to systematically offer additional nutrients to the animal in addition to the hay.

FIG. 8 shows a detailed isometric illustration of the platform 3, which is guided in a vertically displaceable manner in the housing 2 of the animal feed container 1, but isolated from its surrounding housing 2 here.

The platform 3 comprises the horizontal base plate 3a, the upper side of which serves the purpose of receiving the animal feed, in particular hay. This base plate 3a is designed in a robust manner, to evenly carry the feed, and ensures a stable pressure distribution, which is exerted by the compression springs 8.

Several, preferably four, fixedly attached sleeves 11 are located in the corner areas of the base plate 3a on the underside of the base plate 3a of the platform 3, which faces the floor plate 2a of the housing 2. Each of these sleeves 11 serves as outer guide for a vertically running cylindrical compression spring 8, the upper end of which contacts the underside of the base plate 3a and the lower end of which supports itself on the floor plate 2a, wherein a vertical force is exerted upwards onto the platform 3 corresponding to the degree of compression of the compression springs 8 (see FIG. 3). These sleeves 11 guide the compression springs 8 precisely and ensure that the vertical force is exerted evenly on the platform 3, whereby the latter is pushed upwards continuously in the direction of the upper opening 2f.

In order to ensure a stable and torsion-resistant structure of the platform 3, the sleeves 11, which are arranged in the corner areas, are additionally connected to one another by means of fixed struts 12, 13. Two sleeves 11, which lie opposite one another in a direction perpendicular to the front wall 2d and rear wall 2e, are each connected to one another by means of a fixed transverse strut 12. These two transverse struts 12 ensure an improved stability of the platform and prevent a possible tilting during the vertical movement. The two transverse struts 12 are furthermore connected to one another via an additional fixed longitudinal strut 13, which runs perpendicular to the two side walls 2b, 2c. This longitudinal strut 13 additionally reinforces the structural integrity of the platform 3, so that the weight of the animal feed located on the base plate 3a is distributed evenly and an interference-free vertical movement of the platform 3 in the housing 2 is made possible.

The stable structure of the platform 3 ensures an even movement, which is crucial for continuously conveying hay or other feed upwards. A constant and controlled feed supply is thus ensured for the animal, be it a horse, a different farm animal or wild animals.

Although only a few embodiments of the present invention have been shown and described, it is to be understood that many changes and modifications may be made thereunto without departing from the spirit and scope of the invention.

### List of Reference Numerals

1 animal feed container
2 housing
2a floor plate
2b, 2c side wall
2d front wall
2e rear wall
2f upper opening
3 platform
3a base plate
4 spring-actuated mechanism
5 operating element (foot pedal)
6 slot
7 column
8 cylindrical compression spring
9 grate-shaped cover
10 locking device
11 sleeve
12 transverse strut
13 longitudinal strut
14 locking element
15 eye

What is claimed is:

1. An animal feed container (1), comprising:
a housing (2) with a floor plate (2a), two side walls (2b, 2c) as well as a front wall (2d) and a rear wall (2e);
a platform (3) guided in a vertically displaceable manner within the housing (2) for storing animal feed;
a spring-actuated mechanism (4) for raising the platform (3) in the direction of an upper opening (2f) of the housing (2);
an operating element (5) for lowering and fixing the platform (3) in a low position; and
a lateral opening for inserting animal feed into the animal feed container (1) when the platform (3) is fixed in the low position,
wherein the spring-actuated mechanism (4) is configured so that, after releasing the operating element (5), the platform (3) is pushed in the direction of the upper opening (2f) in order to ensure a continuous animal feed supply, and
wherein an L-shaped bracket is fastened as locking element (14) to the floor plate (2a), which is locked in a positive manner with the operating element (5) in the low position in order to thus fix the operating element (5) as well as the platform (3), which is fixedly connected thereto, in the low position.

2. The animal feed container (1) according to claim 1, wherein the housing (2) and/or the platform (3) are made of high-grade steel, in particular stainless steel, and/or plastic.

3. The animal feed container (1) according to claim 1, wherein the platform (3) has a horizontal base plate (3a), which carries the animal feed on its upper side facing the upper opening (2f) and which has several sleeves, preferably four sleeves (11) arranged in the corner areas of the base plate (3a), on its underside facing the floor plate (2a), wherein each sleeve (11) serves as outer guide for a cylindrical compression spring (8), which extends vertically and which supports itself with its upper side on the underside of the floor plate (2a) and exerts a vertical compressive force upwards against the platform (3).

4. The animal feed container (1) according to claim 3, wherein in the case of four sleeves (11), which are arranged in the corner areas of the platform (3), two sleeves (11), which each lie opposite one another in a direction perpendicular to the front wall (2d) and rear wall (2e), are connected to one another by means of a fixed cross strut (12), and the two cross struts (12), in turn, are connected to one another by means of a fixed longitudinal strut (13), which runs perpendicular to the side walls (2b, 2c).

5. The animal feed container (1) according to claim 3, wherein the floor plate (2a) has several columns, preferably four columns (7) arranged in corner areas of the floor plate (2a), wherein each column (7) serves as inner guide for the cylindrical compression spring (8), which extends vertically and which supports itself with its underside on the floor plate (2a) and exerts a vertical compressive force upwards against the platform (3).

6. The animal feed container (1) according to claim 1, wherein the operating element (5) is a foot pedal, which is fixedly connected to the platform (3) and which is operable by the operator by foot and fixable in the low position.

7. The animal feed container (1) according to claim 1, wherein the front wall (2d) has a slot (6), which extends in the vertical direction from the floor plate (2a) and through which the operating element (5) is operable by an operator.

8. The animal feed container (1) according to claim 1, wherein the lateral opening has a flap, which is fastened in an articulated manner and which enables the easy opening and closing of the housing (2), wherein the flap is connected in an articulated manner either to the front wall (2d) or the rear wall (2e) and forms the entire side wall (2b) in the closed state, or wherein the flap is connected in an articulated manner to the side wall (2b) and forms a part of the side wall (2b) in the closed state.

9. The animal feed container (1) according to claim 1, wherein a grate-shaped cover (9) is connected in an articulated manner to the upper edge of the rear wall (2e) and is closeable via a locking device (10) on the front wall (2d) in order to cover the upper opening (2f) in the closed state and to enable a rationed animal feed supply.

10. The animal feed container (1) according to claim 1, wherein a closure lid is provided, which is connected in an articulated manner to the upper edge of the rear wall (2e) in order to completely close the upper opening (2f) and to stop the receipt of animal feed, and wherein the closure lid preferably has one or several indentations, which serve as concentrated feed depressions.

11. The animal feed container (1) according to claim 1, wherein a moistening device, which is connected to a water supply via a hose connection, is integrated into the animal feed container (1) in order to moisten the animal feed, in particular a hay bale, which is stored on the vertically displaceable platform (3).

12. The animal feed container (1) according to claim 1, wherein a sensor monitoring unit is integrated, which monitors the current fill level of the animal feed in the animal feed container (1) by means of magnetic, capacitive or optical sensors and provides the corresponding data via a mobile app.
